(19) United States
(12) Patent Application Publication
(10) Pub. No.: US 2026/0285660 A1
(43) Pub. Date: Sep. 24, 2026

(54) SEAT SYSTEM FOR A VEHICLE FOR LIFTING AND MOVING LOADS

(71) Applicant: Combilift, Co Monaghan (IE)

(72) Inventors: Martin McVicar, Monaghan (IE); Robert Moffett, County Monaghan (IE); Mark Whyte, Co. Monaghan Castleblaney (IE)

(21) Appl. No.: 19/475,829

(22) PCT Filed: Apr. 10, 2024
(86) PCT No.: PCT/EP2024/059718

§ 371 Date: Oct. 16, 2025

(30) Foreign Application Priority Data
Apr. 24, 2023 (GB) 2305983.5

(51) Int. Cl. B66F 9/075; B60N 2/02; B60N 2/14

(52) U.S. Cl. CPC B66F 9/0759; B60N 2/0226; B60N 2/14

(57) ABSTRACT

A seat system for a vehicle for lifting and moving loads has a seat rotation mechanism which is operable in response to control signals received from a control system, to rotate an operator seat relative to a vehicle chassis. The control system receives an input from a directional control used by an operator to steer all of the vehicle's ground-engaging units together relative to the chassis and a direction of travel is changed without changing the orientation of the chassis relative to the ground. The control system outputs a control signal to the seat rotation mechanism to cause the operator seat to rotate towards the direction of travel.

### TECHNICAL FIELD

This invention relates to seat systems for vehicles for lifting and moving loads, and to vehicles for lifting and moving loads having such seat systems.

### BACKGROUND ART

Vehicles for lifting and moving loads, such as fork lift trucks, frequently operate in confined, busy or hazardous environments. In recent years, manufacturers have introduced vehicles with increased manoeuvrability, in particular with multi-directional drive systems. An early example of such a vehicle is disclosed in WO 03/059799. The vehicle in WO 03/059799 is a three-wheeled forklift truck having two front wheels and one rear wheel. The wheels can be steered so that the truck operates in a forward-reverse mode (where the three wheels point, with neutral steering, in the direction of the main axis defined parallel to the forks), a sidewards mode (where the three wheels point, with neutral steering, perpendicular to the main axis) or a carousel mode of operation, with the three wheels lying tangential to a common circle so that the truck can spin in place clockwise or counter-clockwise.

In such a truck the directional mode, e.g. forward-reverse mode or sidewards mode, defines the axis along which the truck is driven with forward or reverse drive (with left or right drive being achieved in sidewards mode by choice of forward or reverse). The directional mode is implemented by rotating all three wheels to point in a common direction (assuming neutral steering), whereas when the truck is in motion and is being steered by the operator, the orientation of the chassis relative to the ground is changed by steering a subset of the wheels in different directions.

For example, in that particular vehicle, when in the forward-reverse mode, the front wheels are not steered but the rear wheel is steered to alter direction of travel, and when in the sidewards mode the two front wheels are steered in opposite directions to one another while the rear wheel is held in a fixed orientation along the trucks forward-reverse axis.

More recent examples of forklift trucks are not limited to two or three directional modes, but allow for a truck to be driven with neutral steering along any direction chosen by the operator using a directional control such as a joystick. Actuating the joystick to e.g. a position of 45 degrees clockwise from the zero degree forward direction (defined for example as the direction in which the forks point) causes the wheels to all rotate together by 45 degrees clockwise, so that if the steering input is neutral, the vehicle will drive at an angle offset of 45 degrees to the orientation of the chassis. Similarly a joystick position of 135 degrees counter-clockwise will cause the truck to crab backwards and sidewards to the left, so that from the driver's perspective the drive direction is towards the 7:30 position on a clockface.

Whenever a vehicle is driving in a direction where the facing direction of the chassis is offset from the direction of travel, the visibility of the driver may be compromised. Typically, drivers use a combination of mirrors and turning their heads to look over their shoulders to have a clear field of vision in the driving direction. However, this can be unsafe and is detrimental to the driver's wellbeing if they spend a significant period of time with their head turned to look sideways or backwards.

### DISCLOSURE OF THE INVENTION

There is provided a seat system for a vehicle for lifting and moving loads, the vehicle being of the type having:
a chassis supported on ground-engaging units selected from wheels and continuous track units, all of the ground-engaging units being steerable relative to the chassis,
a steering control for selectively steering a subset of the ground-engaging units left or right relative to a direction of travel, whereby the orientation of the chassis changes relative to the ground in response to steering control inputs, and
a directional control for steering all of the ground-engaging units left or right together relative to the chassis, whereby the direction of travel may be changed without changing the orientation of the chassis relative to the ground;
   the seat system comprising:
an operator seat;
a seat rotation mechanism operable in response to control signals to rotate the operator seat relative to the vehicle chassis; and
a control system operable to receive an input responsive to an operator input to the directional control, and to output a control signal to the seat rotation mechanism to cause the operator seat to rotate towards the direction of travel.

By providing a seat system with a seat rotation mechanism which is controlled by control signals generated in response to directional control inputs of the type that cause the direction of travel to be changed without changing the orientation of the chassis relative to the ground, the operator's body can be rotated towards the direction of travel, which may eliminate any need to use mirrors or turn one's head, or which may instead reduce the angle that the one needs to turn one's head, avoiding undue strain on the neck by eliminating the most extreme turning motions.

Preferably, the seat rotation mechanism is operable to rotate the seat between a counter-clockwise limit position and a clockwise limit position.

Preferably, the counter-clockwise limit position and/or the clockwise limit position is between 10 and 60 degrees offset from a neutral seating orientation.

More preferred limit positions are from 15 to 30 degrees offset from a neutral seating position.

It has been found that using a limit position in the ranges 10-60 degrees, or more preferably 15-30 degrees, allows for better visibility of the driver while also still allowing easy access to driver controls and instruments that are not rotated along with the seat such as, for example, a steering control.

Preferably, the neutral seating orientation is selected from an orientation defined by one of:
a. a direction towards a windshield of the vehicle;
b. a direction defined parallel to or perpendicular to the axis of one or more forks provided on the vehicle for lifting a load;
c. a direction towards operator pedals;
d. a direction towards a steering wheel;
e. a direction relative to a steering wheel adapted for use by the operator's left or right hand, such that when the seat is in the neutral orientation, the steering wheel is within easy reach of the operator's left or right hand.

In certain implementations, the seat rotation mechanism is operable to rotate the seat to a plurality of fixed positions including the counter-clockwise limit position and the clockwise limit position, with the control system selecting one of the plurality of fixed positions according to the input received.

Preferably, the fixed positions include a neutral position intermediate the counter-clockwise and clockwise limit positions.

Preferably, the neutral position is midway between the counter-clockwise and clockwise limit positions.

However it will be appreciated that there may be a greater degree of rotation in one direction than another, such as a preferentially larger degree of rotation to the clockwise limit position to accommodate the preferences of drivers for looking over their right shoulders when driving backwards.

Preferably, the seat rotation mechanism is operable to rotate the seat to any position from the counter-clockwise limit position to the clockwise limit position, with the control system selecting the rotation position to orient the operator towards the direction of travel where possible.

Preferably, the control system selects the counter-clockwise limit position or the clockwise limit position when the direction of travel lies outside predetermined angular limits.

In some preferred embodiments, the control system defines a neutral driving direction and a neutral seat angle, and wherein for a driving direction which is at an angle A less than a predetermined driving angle A(max), both measured from the neutral driving direction in the counter-clockwise or clockwise sense, the control system selects a seat rotation angle B less than the counter-clockwise or clockwise limit position angle B(max), both measured from the neutral seat angle, wherein the ratio A: A(max) is equal to the ratio B: B(max).

So for example if the predetermined driving angle A(max) is 90 degrees in both the clockwise and counter-clockwise senses, measured from the neutral driving direction defined by the axis between the seat and the center of a vehicle's front windshield, and the clockwise and counter-clockwise limit positions are 24 degrees offset from the neutral seating position which is similarly oriented parallel to the neutral driving direction, then a driving direction at an angle of 60 degrees clockwise from the neutral driving direction (i.e. ⅔ of the angle A(max)) will result in the seat being oriented ⅔ of the way towards the clockwise limit position, i.e. rotated 16 degrees clockwise from the neutral seat angle.

Preferably, the predetermined driving angle A(max) is between 45 degrees and 135 degrees, preferably between 70 and 110 degrees, more preferably between 80 and 100 degrees, most preferably about 90 degrees.

Preferably, the vehicle chassis defines a forward-reverse axis, and wherein the control system selects the counter-clockwise limit position or the clockwise limit position when the vehicle is driven in a direction more than 90 degrees offset from the forward axis in the counter-clockwise or clockwise directions.

Preferably, the control system selects the clockwise limit position when the vehicle is driven in a direction between 90 and 180 degrees offset from the forward axis in the clockwise direction.

Preferably, the control system selects the counter-clockwise limit position when the vehicle is driven in a direction between 90 and 135 degrees offset from the forward axis in the counter-clockwise direction.

Preferably, for a predetermined range of angles lying between 135 and 180 degrees offset from the forward axis, the control system selects the clockwise limit position if the seat was already rotated in the clockwise direction, and selects the counter-clockwise limit position if the seat was already rotated in the counter-clockwise direction.

Preferably, the predetermined range of angles is from a lower limit which is greater than or equal to 135 degrees and less than 180 degrees, to an upper limit of 180 degrees.

Preferably, the seat system comprises a manual rotation control operable to send a control signal to the seat rotation mechanism to rotate the operator seat according to an operator input.

Preferably, the control system is not responsive to the steering control.

Thus, where the vehicle is capable of being driven in a direction of e.g. 90 degrees to the left, and independently can be steered as it is driving in this direction (by the steering of one or more of the wheels differentially from one another), the seat angle will be set according to the direction of driving and will be unaffected as the driver steers the vehicle as it is driven to the left.

Preferably, the seat rotation mechanism does not rotate all of the driver controls together with the seat.

More preferably, the steering control of the vehicle is not rotated with the seat.

Preferably, operator pedals are not rotated with the seat.

By not rotating operator controls such as a steering wheel or operator pedals, a relatively simply and cost-effective solution can be achieved for rotating the seat, possibly along with seat-mounted control inputs, and without the need to re-engineer other systems of the vehicle. Selecting rotation limits for the seat which still allow easy access to the controls not being rotated (e.g. no more than 30 degrees in either direction from neutral) ensures an improved operator experience and less physical strain on the operator.

There is also provided a vehicle for lifting and moving loads, comprising:
a chassis;
a lift mechanism mounted on the chassis;
a plurality of ground-engaging units selected from wheels and continuous track units, all of the ground-engaging units being steerable relative to the chassis, the chassis being supported on the ground-engaging units;
a seat system according to any preceding claim; and
operator controls mounted within reach of the operator seat of the seat system, said operator controls including:
   a steering control for selectively steering a subset of the ground-engaging units left or right relative to a direction of travel, whereby the orientation of the chassis changes relative to the ground in response to steering control inputs; and
   a directional control for selecting a direction of travel of the vehicle, and steering all of the ground-engaging units left or right together relative to the chassis to the selected direction of travel, whereby the direction of travel may be changed without changing the orientation of the chassis relative to the ground.

### BRIEF DESCRIPTION OF THE DRAWINGS

The invention will now be further illustrated by the following description of embodiments thereof, given by way of example only, with reference to the accompanying drawings, in which:

FIG. 1 is a plan view from above of a vehicle for lifting and moving loads;

FIGS. 2-4 are plan views of the seat system of the vehicle of FIG. 1, shown in a neutral position, counter-clockwise limit position, and clockwise limit position, respectively;

FIG. 5 is a plan view of the vehicle of FIG. 1 in a forward directional driving mode;

FIG. 6 is a plan view of the vehicle of FIG. 1 in a reverse directional driving mode;

FIG. 7 is a plan view of the vehicle of FIG. 1 in a right directional driving mode;

FIG. 8 is a plan view of the vehicle of FIG. 1 in a left directional driving mode;

FIG. 9 is a schematic diagram of directional driving zones used in the controlling of the seat system;

FIG. 10 is a flowchart of operation of a state machine for controlling the seat system;

FIG. 11 is a flowchart of operation of the overall seat controller, incorporating the state machine of FIG. 10.

### DETAILED DESCRIPTION OF PREFERRED EMBODIMENTS

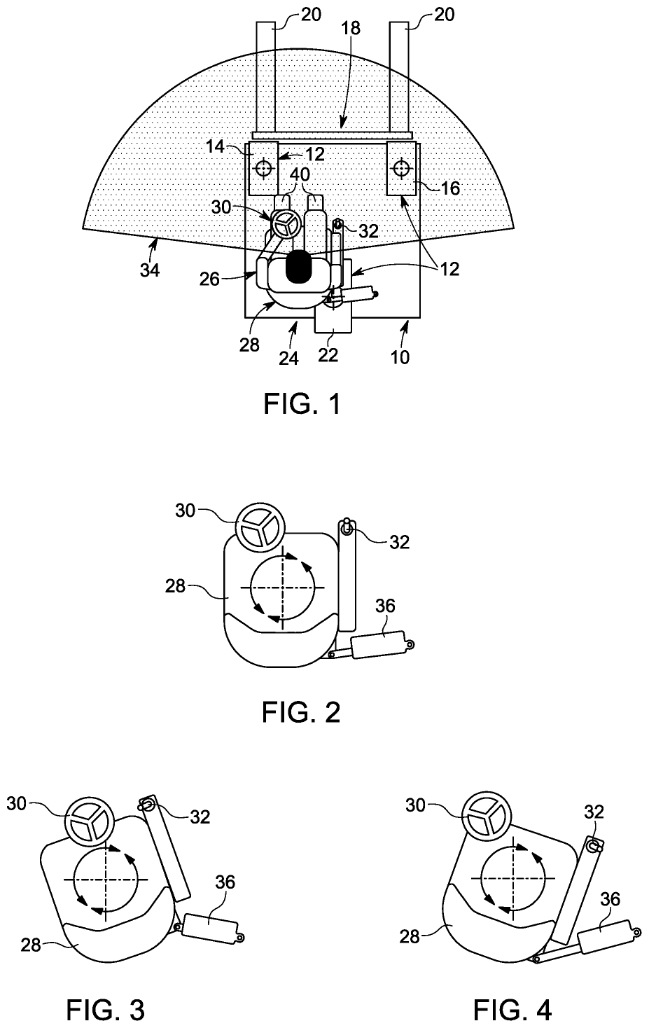

FIG. 1 shows a vehicle for lifting and moving loads in plan view from above, indicated generally at 10, taking the form of a forklift truck. The truck shown has three wheels 12, two of which are front wheels 14, 16 located at a front end 18 of the vehicle chassis adjacent the forks 20, with the third wheel being a rear wheel 22 disposed towards the rear end 24 of the chassis.

It is to be understood that while the illustrated vehicle has three wheels, there can be any number of wheels, provided that they are steerable in a controlled manner to both (a) selectively have a subset of wheels steered (whereby the orientation of the chassis changes relative to the ground in response to such steering when the vehicle is driven with steering applied), and (b) be steered together to a common direction (whereby the direction of travel of the vehicle may be changed without changing the orientation of the chassis relative to the ground when the vehicle is driven after the wheels have been steered together in this way).

It is also to be understood that while the illustrated vehicle has ground-engaging units in the form of wheels, one or more of the wheels could be replaced with a respective continuous track drive.

The operator or driver 26 is seated on a seat 28 with access to a steering control in the form of a steering wheel 30 and a directional control in the form of a joystick 32. The driver has a field of vision 34 of just under 180 degrees forward of the head's direction of orientation, as denoted by a sector of a circle centred on the driver's head.

Referring additionally to FIGS. 2-4, the seat 28 is provided with a rotation mechanism which in the illustrated embodiment comprises an electric linear actuator 36 acting on the base of the seat, with the seat being rotatably mounted relative to the chassis. In FIG. 2, the extendable arm of the electric linear actuator is at mid-stroke, and the seat is in a neutral or central position. In FIG. 3, the arm is fully retracted, which has caused the seat to be rotated counter-clockwise by about 20 degrees from the neutral position. In FIG. 4, the arm is fully extended, causing the seat to be rotated clockwise by about 20 degrees from the neutral position. Therefore this particular seat system has a counter-clockwise limit position shown in FIG. 3 and a clockwise limit position shown in FIG. 4.

The amount of rotation to the limit position in each direction can be different (for example the seat could be arranged to rotate more in the clockwise direction than the counter-clockwise direction or vice versa). For example, given that many drivers prefer to look over their right shoulder while reversing, the clockwise limit position might be at a greater angular offset than the counter-clockwise limit position.

The angular offset of the limit position can be different to the +/−20 degrees shown in the embodiment. While the field of vision of the driver will be adjusted by an accordingly greater angle if the rotation angle of the limit position is increased, the inventors have found that even a small angular offset (for example 10 to 40 degrees, preferably 15 to 30 degrees, more preferably about 20 degrees as shown) gives significant benefit in reducing neck strain on the driver who can still rotate the head and adjust gaze angle to see fully backward, but with 20 degrees less rotation of the neck.

A further benefit of having a relatively modest rotation limit is that the position of the steering wheel 30 and pedals positioned at the driver's feet 40 can remain fixed and it is not necessary to incorporate costly and mechanically complex rotation of the entire console or of a complete operator station including steering wheel, pedals, and instruments. The joystick 32, being mounted in the seat's armrest 40, rotates with the seat.

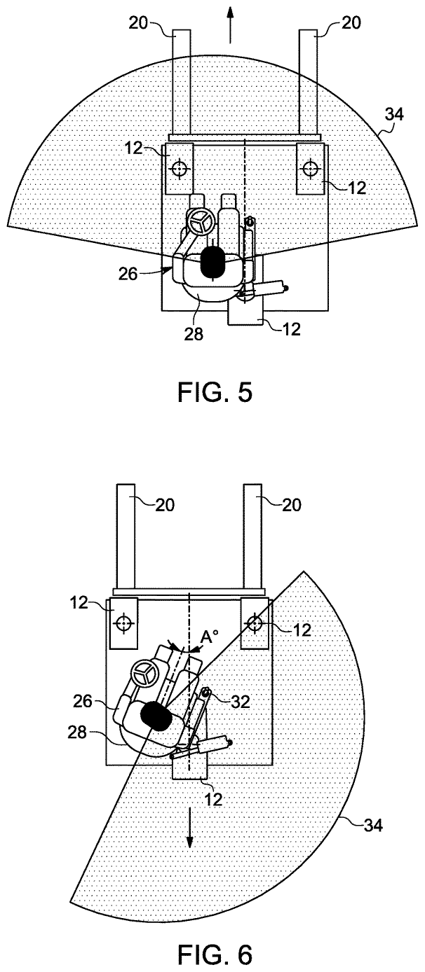

FIG. 5 shows the vehicle in a forward driving mode, with the three wheels 12 pointing in the direction of the forks 20. The operator 26 has a full field of vision forward of the vehicle, and the seat 28 is in the neutral position.

FIG. 6 shows the vehicle when in reverse, this being selected by pulling the joystick 32 backwards. The seat 28 has been rotated 20 degrees to the clockwise limit position, giving the driver more visibility over the right shoulder towards the rear. As shown, the driver still rotates his or her head to see backwards, but the amount of rotation needed is 20 degrees less than if the seat did not rotate.

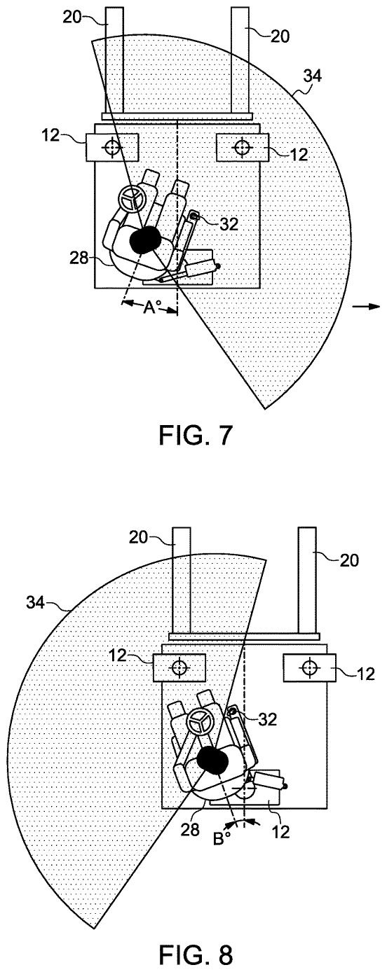

FIG. 7 shows the vehicle being driven to the right, with the directional control (joystick 32) being pushed right to the 3 o'clock position, causing the three wheels 12 to turn together to be perpendicular to the forks 20. The seat 28 has once again been rotated clockwise, to give the driver a better view 34 in the direction of travel, since the orientation of the chassis relative to the ground is unchanged and the vehicle is driving in a direction offset from the normal “forward” axis of the vehicle defined by the front-rear axis.

FIG. 8 shows the vehicle being driven to the left, with the directional control (joystick 32) being pushed left to the 9 o'clock position. Again the wheels 12 have been turned together to be perpendicular to the forks 20. The seat 28 has now been rotated counter-clockwise, to give the driver a better view 34 in the direction of travel.

The vehicle illustrated is provided with a more sophisticated directional control than the vehicles described in WO 03/059799. Rather than being limited to two discrete driving modes (forward-reverse and sidewards) plus a carousel mode, this vehicle can be directed using the joystick to travel at any angle relative to the pointing direction of the chassis. So, for example, a driver could drive the vehicle around a circular path over the ground, without changing the angular orientation of the chassis (in other words, with the forks pointing north at all times), and without using the steering controls. This is done by moving the joystick progressively around the “clockface” while applying drive to the wheels.

The rotation of the seat is, as previously described, achieved by actuating the electric linear actuator inwards and outwards. The linear actuator drives the arm to a desired position according to control signals received from a control system (not shown), which operates in the manner now described.

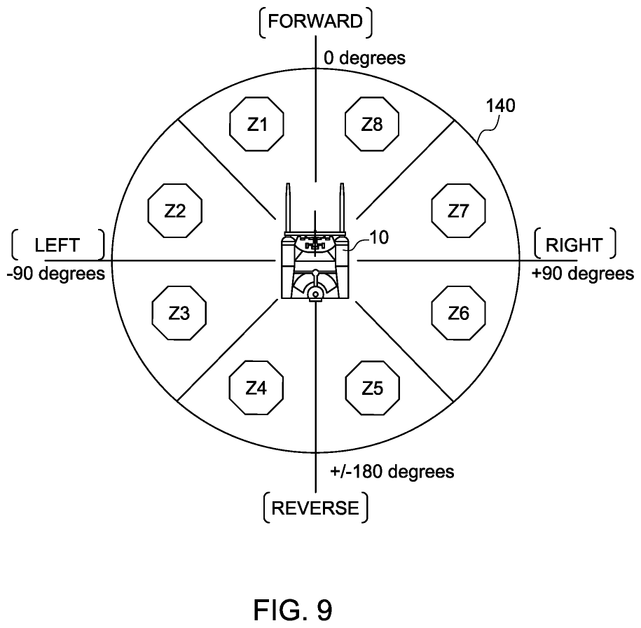

In FIG. 9, the vehicle 10 is shown in the centre of a circle 140 whose area is divided into zones numbered from Z1 to Z8. Starting from the forward direction (marked as 0 degrees) and moving counter-clockwise, each zone Z1 to Z8 occupies a successive 45 degree sector of the circle, i.e.:
Zone 1: angles from 0 degrees to 45 degrees.
Zone 2: angles from 45 degrees to 90 degrees.
Zone 3: angles from 90 degrees to 135 degrees.
Zone 4: angles from 135 degrees to 180 degrees.
Zone 5: angles from 180 degrees to 225 degrees.
Zone 6: angles from 225 degrees to 270 degrees.
Zone 7: angles from 270 degrees to 315 degrees.
Zone 8: angles from 315 degrees to 360 degrees.

The joystick position causes the wheels to rotate together (assuming neutral steering of the steering wheel) to the corresponding angle, which lies within one of the zones, or in a direction lying on a zone boundary (e.g. left at −90 degrees on the boundary between zones Z2 and Z3).

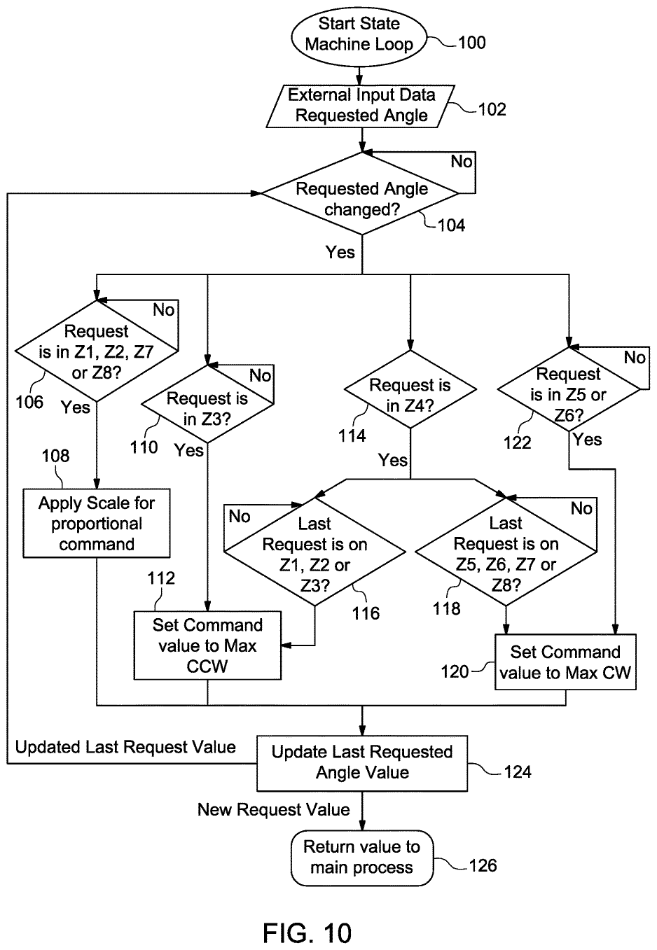

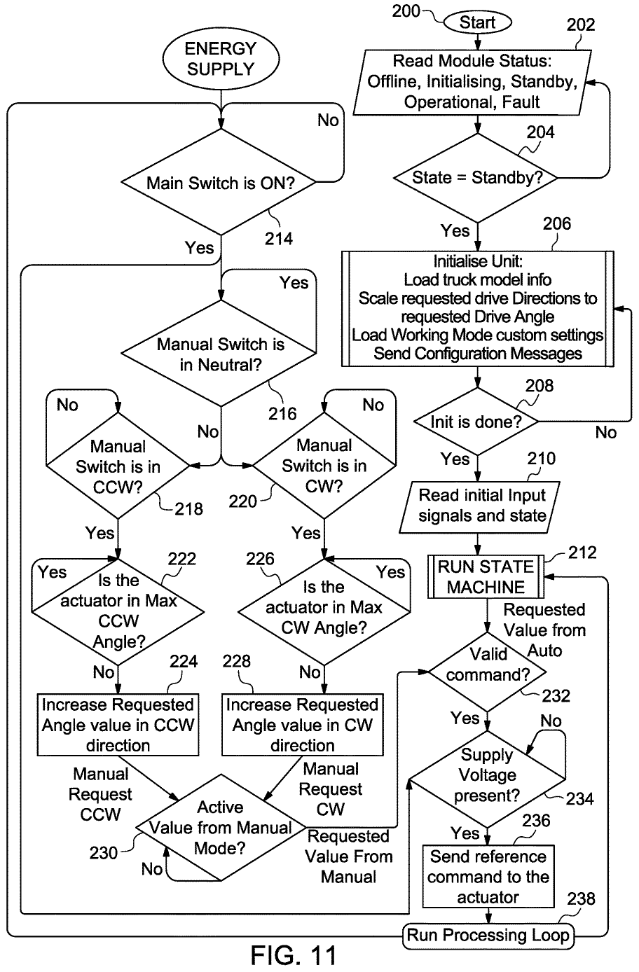

A processor (not shown) is provided in the vehicle and is programmed with instructions implementing a state machine, illustrated in FIG. 10, which in turn forms part of a larger software control system, illustrated in FIG. 11.

Referring to FIG. 10, the state machine starts, step 100, with an input of the current state of the directional orientation of the wheels, and subsequently takes, step 102, as an input the operator's input to the directional control (referred to here as the “requested angle”). A decision is taken, step 104, whether the requested angle represents a change from the current direction. If not the system loops back until such a change is detected.

When a change is detected, the state machine determines which zone the requested angle lies within. If the requested angle is in Z1, Z2, Z7 or Z8, i.e. is in a direction forward of the perpendicular or left-right axis of the truck, step 106, then in step 108 a scale is applied for a proportional command. This means that the amount of rotation to be applied to the seat is set to a proportional value between 0 and 20 degrees clockwise (Z7 or Z8) or counter-clockwise (Z1 or Z2) in proportion to the requested angle between 0 and 90 degrees. So a requested angle of −45 degrees, lying on the Z1-Z2 boundary, would result in a 10 degree seat rotation counter-clockwise, while a requested angle of +67.5 degrees, midway across zone Z7, would result in a 15 degree seat rotation clockwise.

The determination of the seat angle is implemented as calculating a command value to be sent to the seat control actuator, which will be interpreted as a control instruction to extend or retract the electric linear actuator until the arm thereof reaches the stroke position which results in the desired angle of the seat being achieved.

If the requested angle is in zone Z3, step 110, the state machine determines a command value equivalent to maximum counter-clockwise rotation of the seat, step 112.

If the requested angle is in zone Z4, step 114, then a further determination is made as to whether the last requested angle before a zone Z4 input was in Z1, Z2 or Z3, step 116, in which case the command value is set to maximum counter-clockwise, step 112. Alternatively, if the last requested angle before a zone Z4 input was in Z5, Z6, Z7 or Z8, step 118, the command value is set to maximum clockwise, step 120. The reason for this is that zone Z4 represent a reversing direction somewhat to the left. If the vehicle was being driven left beforehand, then it makes sense to keep the driver's orientation to the left, whereas if the position in Z4 is reached from having being driven progressively more rightward into reverse, with the seat having been rotated clockwise, then it makes sense for the seat to remain fully clockwise.

If the requested angle is in zone Z5 or Z6, step 122, the state machine determines a command value equivalent to maximum clockwise rotation of the seat, step 120.

When a command value is set in step 108, 112 or 120, the state machine updates the last requested value according to the new value, step 124 (this can be done by storing the actual value or the zone identifier), and this is used in the next comparison in step 104. If the requested value has changed on this iteration, the new seat rotation command value is returned to the main process, step 126 in order to rotate the seat as will be discussed in relation to FIG. 11.

It will be noted that in this particular implementation, if the requested angle moves from zone Z5 to Z4, the seat remains fully rotated in the clockwise direction. If the requested angle moves from zone Z4 to Z5, the seat will rotate from fully counter-clockwise to fully clockwise. This reflects a preference, when driving in reverse, for most drivers to preferentially look over their right shoulder. However, it is possible to change the logic as the system designers wish, so that for example in either zone Z4 or Z5 the seat could remain in the limit position it was previously in, i.e. when moving from Z5 to Z4 it would remain at the clockwise limit, but if moving from Z4 to Z5 it would remain at the counter-clockwise limit. Also an operator preference setting could be recorded to implement a preference for looking over the left-hand shoulder, so that Z4 would always result in fully counter-clockwise rotation, while Z5 would depend on the last requested angle (as currently shown for Z4) with the seat remaining fully counter-clockwise if the last request was in Z1, Z2, Z3 or Z4, thereby providing a bias towards counter-clockwise rotation.

It is also to be understood that the described implementation in terms of zones is not essential. A simpler control mechanism could simply rotate the seat counter-clockwise when the direction was in to the left, perhaps above a given threshold angle, and vice versa for the right direction with a clockwise rotation. Such a simple control system could have a single seat rotation angle, or perhaps a discrete set of seat rotation angles, selected depending on the angle of direction relative to the forward (fork-pointing) axis of the vehicle.

It is also to be understood that while the described vehicle has a natural orientation of a forward axis towards the forks, this being shown by the positioning of the steering wheels, there are other vehicles with forks to the side of the driver and the seat rotation angles will then be calculated according to the vehicle's normal forward direction angle. The important point is for the seat to rotate to give the driver a better view in the direction of travel, when the vehicle is driven in a direction that is not where the driver normally faces.

Referring to FIG. 11, a flowchart of operation of the overall seat control is shown. After system start, step 200, a self-check is performed on the status of the system, step 202, which can result in one of the values: offline, initialising, standby, operational, fault. If the state is not standby, step 204, the system waits until it is in standby before proceeding.

In step 206, the system initialises by loading the information for the specific truck model in which the software is operating (this may include vehicle-specific and equipment-specific parameters that will affect what kinds of control signals need to be sent to the installed seat equipment). Depending on the vehicle, the requested drive direction will need to be scaled to the requested drive angle. Any custom settings (e.g. operator preferences) are loaded into the working mode, and finally configuration messages are sent to other systems of the vehicle.

A check is made that the initialisation is complete, step 208, and once complete, the initial input signals from the directional control, and the state of the seat rotation are read, step 210. For example, this might result in values of the seat being fully clockwise at the limit position, and the directional control being set to straight ahead (forward, zero degrees). These values are then passed into the state machine of FIG. 10, which returns a command value as previously described, step 212. In parallel to the automatic sear rotation, there is a manual seat rotation control in place, which the operator can control using a toggle switch with CCW (counter-clockwise), neutral, and CW (clockwise) position settings. Preferably the switch is spring loaded to the neutral position and the operator can toggle left or right (CCW or CW) to rotate the seat towards the desired direction.

The manual part of the system operates starting at step 214 with a check that the main switch is on. If so, the position of the manual switch is polled to determine if it is in the neutral position, step 216. If it is in the manual position, then no action is needed.

If the switch is not in manual position, there are two possibilities: the switch is in the CCW position, step 218 or the switch is in the CW position, step 220. If the switch is in the CCW position at step 218, the state of the actuator control (i.e. the electric linear actuator control in this implementation) is checked to see if the seat is already at the maximum CCW position, step 222. If so, no further rotation is possible and no action is taken. If it is not yet at maximum CCW rotation, then in step 224 the system increases the requested angle value for the seat in the CCW direction. In the case that the manual switch is in the CW position in step 220, then similar checks are made in steps 226 and 228 to request a clockwise rotation if the seat is not already at the clockwise limit.

If a manual change in angle is requested, either CCW or CW, this is noted in step 230, and the value is passed to a decision point, step 232, which receives command values from both the manual branch at step 230 and the state machine (automatic rotation branch) at step 212. If the command is a valid command, then a check is made, step 234, that a supply voltage is present to actuate the seat (this being determined from a signal passed from the main switch electronics at step 214). If there is a valid command and if a supply voltage is present, then the appropriate reference command is sent to the actuator to cause the seat to be rotated to the desired angle, step 236, before the loop proceeds to the next iteration, step 238.

The flowchart of FIG. 11 and the state machine of FIG. 10 are typically implemented in a suitable programming language, stored in a persistent storage location and loaded into a processor of a computing system at runtime. The instructions to implement the flowchart can also be implemented in firmware. The computing system or the firmware are integrated with the computing and information systems of the vehicle, and may be implemented as a software module running on a general purpose processor used in several vehicle control systems.

The command signals sent to the actuator of the seat system will be dependent on the type of actuator and the required range of rotation. The command signals to a hydraulic cylinder will be different from, and calibrated differently to, the command signals sent to a rotary electric motor, for example. A hydraulic cylinder implementation would receive control signals suitable to actuate a pump to push or pull fluid from the cylinder, while signals sent to an electric linear actuator might define a position to be achieved by a stepper motor. Some actuators will have a linear relationship between the actuation mechanism and the ultimate seat rotation angle, while others may have a non-linear relationship for which calibration is non-linear.

Whereas the actuator in the illustrated embodiment is an electric linear actuator, the scope is in no way limited to such a rotation mechanism. Any suitable mechanism for rotating a seat to a desired angle may be employed, such as a hydraulic cylinder, an electrical linear actuator, an electric or hydraulic rotary motor, etc.

1. A seat system for a vehicle for lifting and moving loads, the vehicle being of the type having:
a chassis supported on ground-engaging units selected from wheels and continuous track units, all of the ground-engaging units being steerable relative to the chassis,
a steering control for selectively steering a subset of the ground-engaging units left or right relative to a direction of travel, whereby an orientation of the chassis changes relative to the ground in response to steering control inputs, and
a directional control for steering all of the ground-engaging units left or right together relative to the chassis, whereby the direction of travel is changed without changing the orientation of the chassis relative to the ground;
the seat system comprising:
an operator seat;
a seat rotation mechanism operable in response to control signals to rotate the operator seat relative to the chassis; and
a control system operable to receive an input responsive to an operator input to the directional control, and to output a control signal to the seat rotation mechanism to cause the operator seat to rotate towards the direction of travel.

2. A seat system according to claim 1, wherein the seat rotation mechanism is operable to rotate the operator seat between a counter-clockwise limit position and a clockwise limit position.

3. A seat system according to claim 2, wherein at least one selected from the group consisting of (a) the counter-clockwise limit position is between 10 and 60 degrees offset from a neutral seating orientation and (b) the clockwise limit position is between 10 and 60 degrees offset from the neutral seating orientation.

4. A seat system according to claim 3, wherein the neutral seating orientation is selected from an orientation defined by one selected from the group consisting of:
a. a direction towards a windshield of the vehicle;
b. a direction defined parallel to or perpendicular to an axis of one or more forks provided on the vehicle for lifting a load;
c. a direction towards operator pedals;
d. a direction towards a steering wheel; and
e. a direction relative to a steering wheel adapted for use by the operator's left or right hand, such that when the operator seat is in the neutral seating orientation, the steering wheel is within easy reach of the operator's left or right hand.

5. A seat system according to claim 4, wherein the seat rotation mechanism is operable to rotate the operator seat to a plurality of fixed positions including the counter-clockwise limit position and the clockwise limit position, with the control system selecting one of the plurality of fixed positions according to the input received.

6. A seat system according to claim 5, wherein the fixed positions include a neutral position intermediate the counter-clockwise limit position and the clockwise limit position.

7. A seat system according to claim 6, wherein the neutral position is midway between the counter-clockwise limit position and the clockwise limit position.

8. A seat system according to claim 7-any wherein the seat rotation mechanism is operable to rotate the operator seat to a rotation any-position from the counter-clockwise limit position to the clockwise limit position, with the control system selecting the rotation position to orient the operator towards the direction of travel where possible.

9. A seat system according to claim 8, wherein the control system selects the counter-clockwise limit position or the clockwise limit position when the direction of travel lies outside predetermined angular limits.

10. A seat system according to claim 8, wherein the control system defines a neutral driving direction and a neutral seat angle, and wherein for a driving direction which is at an angle A less than a predetermined driving angle A(max), both measured from the neutral driving direction in a the counter-clockwise direction or a clockwise direction the control system selects a seat rotation angle B less than the counter-clockwise limit position or the clockwise limit position angle B(max), both measured from the neutral seat angle, wherein the ratio A: A(max) is equal to the ratio B: B(max).

11. A seat system according to claim 10, wherein the predetermined driving angle A(max) is at least one selected from the group consisting of (a) between 45 degrees and 135 degrees, (b) between 70 degrees and 110 degrees, (c) between 80 degrees and 100 degrees, and (d) about 90 degrees.

12. A seat system according to claim 11, wherein the chassis defines a forward-reverse axis, and wherein the control system selects the counter-clockwise limit position or the clockwise limit position when the vehicle is driven in a direction more than 90 degrees offset from the forward axis in the counter-clockwise direction or the clockwise direction.

13. A seat system according to claim 12, wherein the control system selects the clockwise limit position when the vehicle is driven in a direction between 90 degrees and 180 degrees offset from the forward axis in the clockwise direction.

14. A seat system according to claim 13, wherein the control system selects the counter-clockwise limit position when the vehicle is driven in a direction between 90 degrees and 135 degrees offset from the forward axis in the counter-clockwise direction.

15. A seat system according to claim 14, wherein for a predetermined range of angles lying between 135 degrees and 180 degrees offset from the forward axis, the control system selects the clockwise limit position if the operator seat was already rotated in the clockwise direction, and selects the counter-clockwise limit position if the operator seat was already rotated in the counter-clockwise direction.

16. A seat system according to claim 15, wherein the predetermined range of angles is from a lower limit which is greater than or equal to 135 degrees and less than 180 degrees, to an upper limit of 180 degrees.

17. A seat system according to claim 1, further comprising a manual rotation control operable to send a control signal to the seat rotation mechanism to rotate the operator seat according to an operator input.

18. A seat system according to claim 1, wherein the control system is not responsive to the steering control.

19. A seat system according to claim 1, wherein the seat rotation mechanism does not rotate driver controls together with the operator seat.

20. A seat system according to claim 19, wherein the steering control of the vehicle is not rotated with the operator seat.

21. A seat system according to claim 20, wherein operator pedals are not rotated with the operator seat.

22. A vehicle for lifting and moving loads, comprising:
a chassis;
a lift mechanism mounted on the chassis;
a plurality of ground-engaging units including at least one selected from the group consisting of (a) wheels and (b) continuous track units, all of the ground-engaging units being steerable relative to the chassis, the chassis being supported on the ground-engaging units;
a seat system comprising:
an operator seat;
a seat rotation mechanism operable in response to control signals to rotate the operator seat relative to the chassis; and
a control system;
operator controls mounted within reach of the operator seat of the seat system, said operator controls including:
a steering control for selectively steering a subset of the ground-engaging units left or right relative to a direction of travel, whereby the orientation of the chassis changes relative to the ground in response to steering control inputs; and
a directional control for selecting a direction of travel of the vehicle, and steering all of the ground-engaging units left or right together relative to the chassis to the selected direction of travel, whereby the direction of travel is changed without changing the orientation of the chassis relative to the ground; and
wherein the control system of the seat system is operable to receive an input responsive to an operator input to the directional control and to output a control signal to the seat rotation mechanism to cause the operator seat to rotate towards the direction of travel.
